(19) United States
(12) Patent Application Publication
(10) Pub. No.: US 2014/0094276 A1
(43) Pub. Date: Apr. 3, 2014

(54) COMMUNITY GAMING SYSTEM WITH VARYING ELIGIBILITY CRITERIA

(71) Applicant: WMS GAMING INC., Waukegan, IL (US)

(72) Inventors: Matthew J. Ward, Northbrook, IL (US); Mark B. Gagner, West Chicago, IL (US); Joel R. Jaffe, Glenview, IL (US)

(73) Assignee: WMS GAMING INC., Waukegan, IL (US)

(21) Appl. No.: 13/783,584

(22) Filed: Mar. 4, 2013

Related U.S. Application Data
(60) Provisional application No. 61/707,244, filed on Sep. 28, 2012.

(51) Int. Cl. G07F 17/32

(52) U.S. Cl. CPC G07F 17/3272
USPC 463/25

(57) ABSTRACT

A computer-implemented method includes displaying a community game on at least one display device. Dependent upon a first player playing an underlying wagering game via a first terminal, the first player is permitted to participate in the community game. The community game is distinct from the underlying wagering game. Not dependent upon a second player playing an underlying wagering game via a second terminal, the second player is permitted to participate in the community game.

### CROSS-REFERENCE To RELATED APPLICATION

This application claims the benefit of U.S. Provisional Application No. 61/707,244, filed Sep. 28, 2012, which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to wagering game systems and, more particularly, to a community gaming system with varying eligibility criteria.

### BACKGROUND

Gaming machines or terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing terminals and the expectation of winning each terminal is roughly the same (or believed to be the same), players are most likely to be attracted to the more entertaining and exciting terminal. As a result, wagering game machine operators strive to employ the most entertaining and exciting machines available, because such machines attract frequent play and provide increased profitability for the operators.

### SUMMARY OF THE INVENTION

A computer-implemented method includes displaying a community game on at least one display device. Dependent upon a first player playing an underlying wagering game via a first terminal, the first player is permitted to participate in the community game. The community game is distinct from the underlying wagering game. Not dependent upon a second player playing an underlying wagering game via a second terminal, the second player is permitted to participate in the community game.

A gaming system for conducting a wagering game including a community game includes one or more display devices, one or more processors, and one or more memory devices storing instructions that, when executed by at least one of the one or more processors, cause the gaming system to display a community game on at least one of the one or more display devices. Dependent upon a first player playing an underlying wagering game via a first terminal, the gaming system is further caused to permit the first player to participate in the community game. The community game is distinct from the underlying wagering game. Not dependent upon a second player playing an underlying wagering game via a second terminal, the gaming system is further caused to permit the second player to participate in the community game.

One or more physical machine-readable storage media including instructions which, when executed by one or more processors, cause the one or more processors to perform operations including displaying a community game on at least one display device. Dependent upon a first player playing an underlying wagering game via a first terminal, the operations further include permitting the first player to participate in the community game. The community game is distinct from the underlying wagering game. Not dependent upon a second player playing an underlying wagering game via a second terminal, the operations further include permitting the second player to participate in the community game.

A computer-implemented method includes displaying a community game on at least one display device. Dependent upon a first player playing a first underlying wagering game via a first terminal wherein the first underlying wagering game funds the community game, the first player is permitted to participate in the community game. Dependent upon a second player playing a second underlying wagering game via a second terminal wherein the second underlying wagering game does not fund the community game, the second player is permitted to participate in the community game.

One or more physical machine-readable storage media including instructions which, when executed by one or more processors, cause the one or more processors to perform operations comprising displaying a community game on at least one display device. Dependent upon a first player playing a first underlying wagering game via a first terminal wherein the first underlying wagering game funds the community game, the first player is permitted to participate in the community game. Dependent upon a second player playing a second underlying wagering game via a second terminal wherein the second underlying wagering game does not fund the community game, the second player is permitted to participate in the community game.

A method for conducting a wagering game including a community game includes receiving, via a first input device, a first wager from a first player of the wagering game on a first gaming terminal having game logic for determining an outcome of the wagering game based on a randomly generated number. A second wager is received, via a second input device, from a second player of the wagering game on a second gaming terminal lacking game logic for determining an outcome of the wagering game. The community game is caused to be triggered. A determination is made as to whether the first player of the wagering game on the first gaming terminal is eligible to play the triggered community game based on a first eligibility criterion. A second determination is made as to whether the second player of the wagering game on the second gaming terminal is eligible to play the triggered community game based on a second eligibility criterion that is distinct from the first eligibility criterion. The community game is conducted including displaying, on at least one community display device, a community game outcome that is the same for the first player and the second player.

A gaming system for conducting a wagering game including a community game includes a first input device, a second input device, one or more display devices, one or more processors, and one or more memory devices. The first input device is of a first gaming terminal has game logic for determining an outcome of the wagering game based on a randomly generated number. The second input device is of a second gaming terminal lacks game logic for determining an outcome of the wagering game. The one or more memory devices store instructions that, when executed by at least one of the one or more processors, cause the gaming system to: (i) receive, via the first input device, a first input indicative of a wager to play the wagering game, (ii) receive, via the second input device, a second input indicative of a wager to play the wagering game, (iii) cause the community game to be triggered, (iv) determine if a first player of the wagering game on the first gaming terminal is eligible to play the triggered community game based on a first eligibility criterion, (v) determine if a second player of the wagering game on the second gaming terminal is eligible to play the triggered community game based on a second eligibility criterion that is distinct from the first eligibility criterion, and (vi) conduct the community game including displaying, on at least one of the one or more display devices, a community game outcome that is the same for the first player and the second player.

One or more physical machine-readable storage media including instructions which, when executed by one or more processors, cause the one or more processors to perform the following operations. A first wager to play a first basic wagering game on a first gaming terminal having game logic for determining an outcome of the first basic wagering game based on a randomly generated number is received via a first input device. A second wager to play a second basic wagering game on a second gaming terminal lacking game logic for determining an outcome of the second basic wagering game is received via a second input device. A community game is caused to be triggered. Whether a first player of the first basic wagering game on the first gaming terminal is eligible to play the triggered community game based on a first eligibility criterion is determined. Whether a second player of the second basic wagering game on the second gaming terminal is eligible to play the triggered community game based on a second eligibility criterion that is distinct from the first eligibility criterion is determined. The community game is conducted including displaying, on a community display device, a community game outcome.

A method for conducting a wagering game including a basic game and a community game includes establishing a first communication link with a first gaming terminal having game logic for determining an outcome of the basic game based on a randomly generated number. A second communication link is established with a second gaming terminal lacking game logic for determining an outcome of the basic game. The community game is triggered. Whether a first player of the wagering game on the first gaming terminal is eligible to play the triggered community game based on a first eligibility criterion is determined. Whether a second player of the wagering game on the second gaming terminal is eligible to play the triggered community game based on a second eligibility criterion that is distinct from the first eligibility criterion is determined. The community game is caused to be conducted including causing a community game outcome to be displayed, on at least one community display device, that is the same for the first player and the second player.

A gaming system for conducting a wagering game including a community game includes a first input device, a second input device, one or more display devices, one or more processors, and one or more memory devices. The first input device of a first gaming terminal has game logic for determining an outcome of the wagering game based on a randomly generated number. The second input device of a second gaming terminal lacks game logic for determining an outcome of the wagering game. The one or more memory devices store instructions that, when executed by at least one of the one or more processors, cause the gaming system to: (i) establish a first communication link with the first gaming terminal, (ii) establish a second communication link with the second gaming terminal, (iii) trigger the community game, (iv) determine if a first player of the wagering game on the first gaming terminal is eligible to play the triggered community game based on a first eligibility criterion, (v) determine if a second player of the wagering game on the second gaming terminal is eligible to play the triggered community game based on a second eligibility criterion that is distinct from the first eligibility criterion, and (vi) conduct the community game including displaying, on at least one of the one or more display devices, a community game outcome that is the same for the first player and the second player.

Additional aspects of the present disclosure will be apparent to those of ordinary skill in the art in view of the detailed description of various implementations, which is made with reference to the drawings, a brief description of which is provided below.

### BRIEF DESCRIPTION OF THE DRAWINGS

FIG. 1 is a perspective view of a free-standing gaming terminal according to some aspects of the present disclosure;

FIG. 2 is a schematic view of a gaming system according to some aspects of the present disclosure;

FIG. 3 is an image of an exemplary basic-game screen of a wagering game displayed on a gaming terminal according to some aspects of the present disclosure;

FIG. 4 is perspective view of a gaming system according to some aspects of the present disclosure;

FIG. 5 is a screen shot of a display of a free-standing gaming terminal of the gaming system of FIG. 4;

FIGS. 6 and 7 is a screen shot of a display of a portable gaming terminal of the gaming system of FIG. 4;

FIG. 8 is a screen shot of a community display of the gaming system of FIG. 4 illustrating some aspects of a community game;

FIG. 9A is a screen shot of the community display of the gaming system of FIG. 4 illustrating some additional aspects of the community game;

FIG. 9B is a screen shot of the display of the portable gaming terminal of the gaming system of FIG. 4a illustrating the community game;

FIG. 10A is a screen shot of the display of the free-standing gaming terminal of the gaming system of FIG. 4 illustrating some additional aspects of the community game; and

FIG. 10B is a screen shot of the display of the portable gaming terminal of the gaming system of FIG. 4 illustrating some additional aspects of the community game.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the disclosure is to cover all modifications, equivalents, and alternatives falling within the spirit and scope of the present invention as defined by the appended claims.

### DETAILED DESCRIPTION

While this disclosure is susceptible of embodiment in many different forms, there is shown in the drawings and will herein be described in detail preferred embodiments of the disclosure with the understanding that the present disclosure is to be considered as an exemplification of the principles of the disclosure and is not intended to limit the broad aspect of the disclosure to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

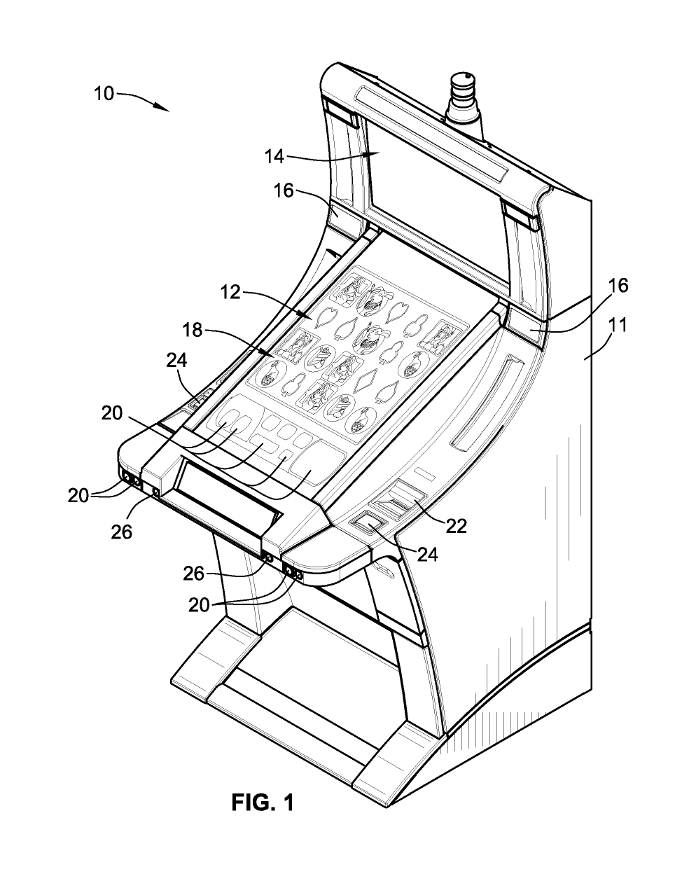

Referring to FIG. 1, there is shown a gaming terminal 10 similar to those used in gaming establishments, such as casinos. With regard to the present disclosure, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. U.S.2010/0062196 and U.S.2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

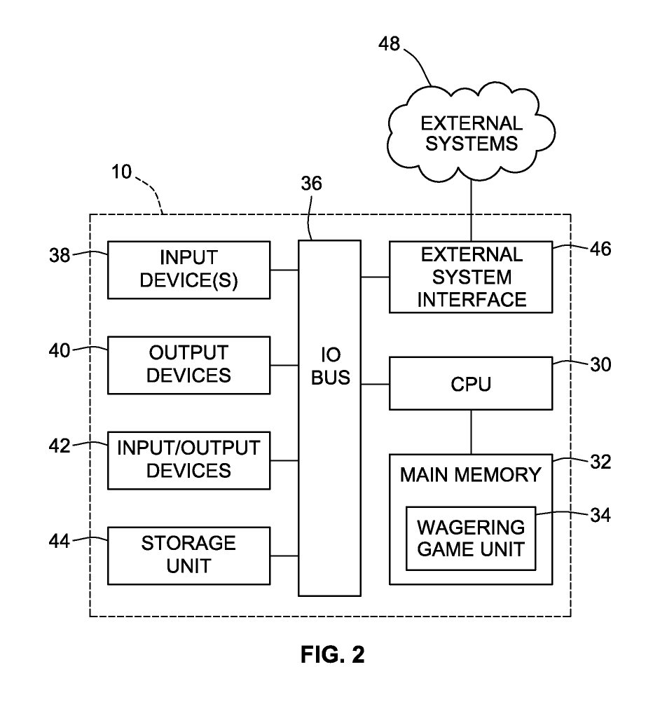

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

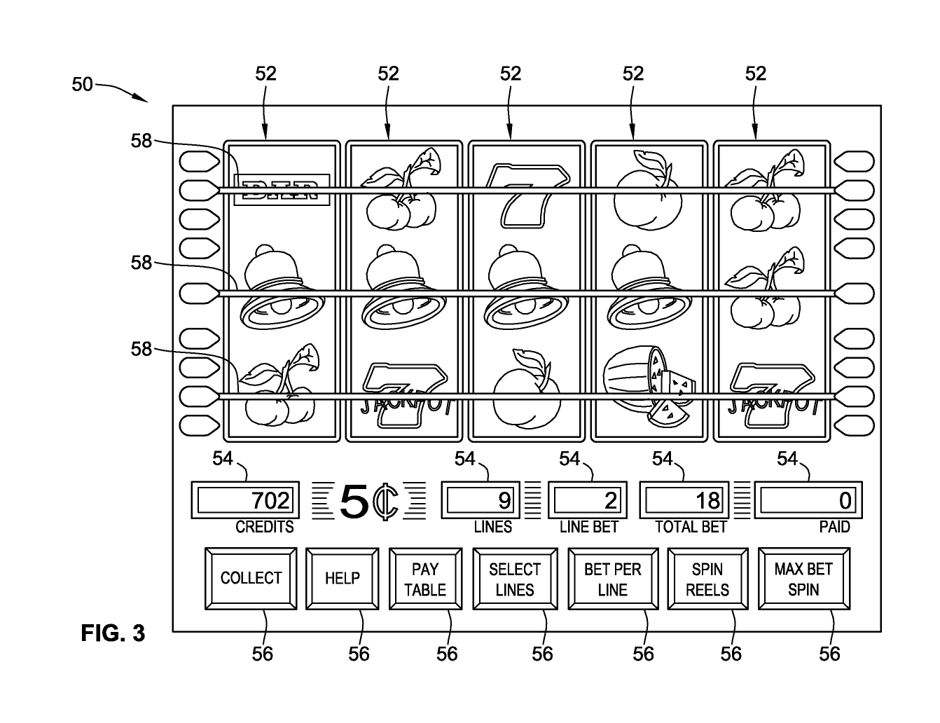

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

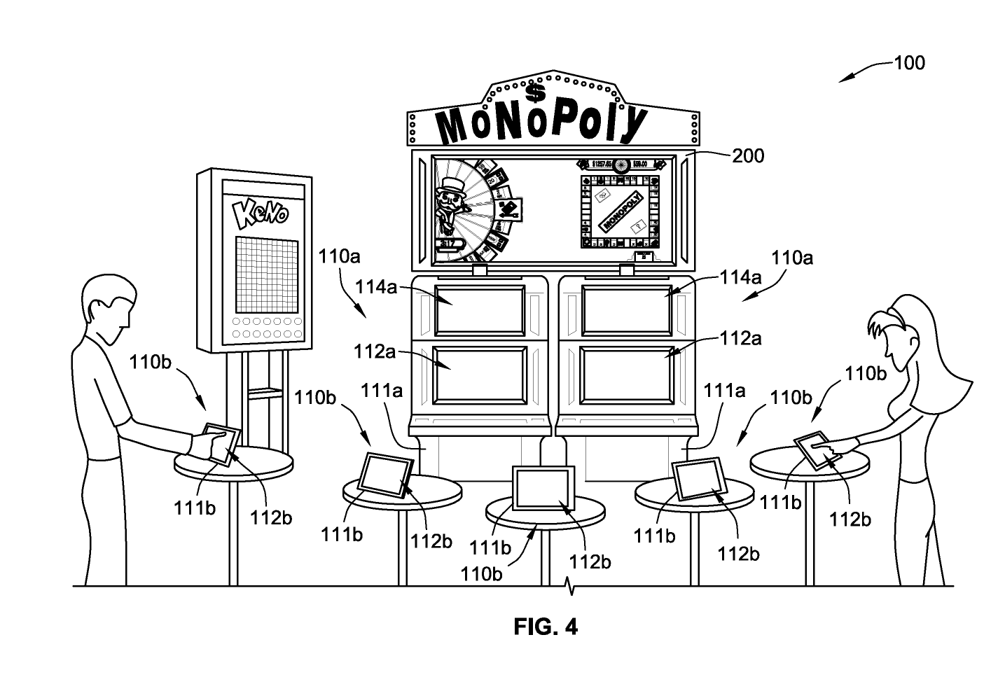

Referring to FIG. 4, a gaming system 100 includes gaming terminals 110a of a first type, gaming terminals 110b of a second type, a community display device 200, and a gaming server (not shown). The first type of gaming terminals 110a are thick clients and the second type of gaming terminals 110b are thin clients. By thick client, as described above, it is meant that a housing 111a of each of the first type of gaming terminals 110a includes an RNG, game logic, and game assets therein (e.g., the RNG, game logic, and game assets are onboard). By thin client, as described above, it is meant that a housing 111b of each of the second type of gaming terminals 110b does not include (e.g., lacks) an RNG, game logic, and pre-stored game assets therein (e.g., the RNG, game logic, and game assets are external). The game logic and the game assets can be downloaded to the gaming terminals 110b in real time or just prior to being displayed on the gaming terminals 110b, but they do not reside there except temporarily to support real-time functions of a wagering game displayed on the gaming terminals 110b. In some implementations, the game assets can be buffered to the gaming terminals 110b. By “lacking” game logic or game assets, it is meant that game assets are not stored on the gaming terminals 110b until requested by a web browser of the gaming terminals 110b. As those of ordinary skill in the art understand, when data is downloaded from a server to a client, it resides on the client at least temporarily (e.g., in buffered form), but the data originates from the server where it is stored. When the downloaded data is no longer needed by the requesting web page, it can be discarded or overwritten.

Each of the gaming terminals 110a of the first type can be a floorstanding gaming terminal, such as, for example, the gaming terminal 10 described above (e.g., free-standing gaming terminal). Each of the gaming terminals 110b of the second type can be a handheld device, such as, for example, a personal computer (e.g., laptop), a tablet computer (e.g., IPAD tablet computer, EEE PAD tablet computer, KINDLE tablet computer, etc.), and/or a smart phone (e.g., IPHONE smart phone, SAMSUNG GALAXY smart phone, etc.). In some implementations, the gaming terminals 110a of the first type are primarily dedicated to wagering games and/or for playing wagering games thereon, whereas, the gaming terminals 110b of the second type are not primarily dedicated to wagering games and/or for playing wagering games thereon.

In some implementations, the manufacturer of the gaming terminals 110b of the second type is not affiliated with the manufacturer of the gaming terminals 110a of the first type and/or the provider of the wagering game (e.g., software) played/executed thereon. Further, in an implementation of the gaming system 100 in a gaming establishment such as a casino, whereas the gaming terminals 110a of the first type can be supplied by the casino, one or more of the gaming terminals 110b of the second type can be independently owned and operated and/or brought into the casino by an individual patron of the casino.

Additionally, the gaming terminals 110b of the second type can differ from the gaming terminals 110a of the first type in that the gaming terminals 110b of the second type require the player to sign in or log into an account to play a wagering game thereon, whereas the players of the gaming terminals 110a of the first type do not necessarily need to sign in or log into an account to play a wagering game thereon.

The gaming terminals 110b of the second type can include an image capturing device (e.g., a camera) for capturing a QR code (e.g., quick response code). The QR code can be displayed (e.g., on a video display or on a printed medium) near the gaming system 100, on a housing 111a of one of the gaming terminals 110a of the first type, elsewhere in a building housing the gaming system 100 (e.g., casino), or anywhere viewable to a potential player of a wagering game. Once captured, the gaming terminals 110b of the second type can decode the QR code and launch responsive software (e.g., a web browser) and direct the player to a specific menu and/or website. For example, in response to capturing a QR code, the gaming terminals 110b of the second type can display a menu of wagering games (e.g., basic wagering games, community games, side games, etc.), from which the player can select and play. The wagering games can be hosted by the gaming terminals 110a of the first type or by a remote (i.e., remote from the gaming terminals 110a and 110b) host or gaming server, such as represented by the external systems 48 shown in FIG. 2, or a combination of both. The QR code can encode, for example, a uniform resource locator that directs a web browser to a web page that includes the menu of wagering games or directly to a wagering game landing page.

While the gaming terminals 110b of the second type are shown as being proximate to the gaming terminals 110a of the first type (e.g., within 10-15 feet), the gaming terminals 110b can be positioned anywhere (e.g., anywhere within a casino housing the gaming system 100, remote from a casino housing the gaming terminals 110a, etc.).

The community display device 200 is generally positioned above the gaming terminals 110a of the first type such that a community game displayed thereon can be readily viewed by players of all of the gaming terminals 110a and 110b in the viewing vicinity of the community display device 200. The community display device 200 can be a single display device (e.g., one plasma video display) or multiple (e.g., two, three, four, etc.) display devices coupled together for displaying the community game thereon.

The gaming server (not shown) is communicatively connected (e.g., directly or indirectly) via one or more communication links (e.g., wired connection, wireless connection, both, etc.) to each of the gaming terminals 110a, each of the gaming terminals 110b, and the community display device 200. The communication links can be permanent and/or established by the gaming server. For example, if a new gaming terminal 110b of the second type (e.g., a new tablet computer) enters a predetermined range of the gaming system 100, the gaming server can be configured to establish a communications link (e.g., wireless) therewith. In some implementations, prior to establishing a communication link between the server and one of the gaming terminals 110b of the second type, the gaming terminal 110b must (i) join and/or connect to a wireless network of the server (e.g., a WIFI network broadcast by the server), (ii) direct its internet browser to a particular URL, (iii) activate an application thereon (e.g., launch an app), or any combinations thereof.

The gaming server can be physically integrated with one of the gaming terminals 110a of the first type. For example, the gaming server can be included in the housing 111a of one of the gaming terminals 110a of the first type. Alternatively, the gaming server can be located remote from the gaming terminals 110a, 110b (e.g., in a different room or area of a casino, in a different state or country, etc.).

The gaming server includes one or more RNGs, game logic, and game assets for any of the wagering games disclosed herein, including the community game. Specifically, the gaming server can act like a thick client that uses the one or more RNGs to generate random numbers, game logic for determining outcomes based on the randomly generated numbers, and game assets (e.g., images, animations, audio files, etc.) for presenting the determined outcome to players in an audio-visual manner. The presenting of the determined outcomes is not displayed on the gaming server, but, rather the determined outcomes and/or game assets are electronically transferred to one or more gaming terminals for display thereon. For example, an outcome determined by the gaming server can be transferred to and displayed on one or more of the gaming terminals 110b of the second type.

The gaming system 100 provides one or more games for a multitude of players to play via the gaming terminals 110a, 110b. Each of the games on each of the gaming terminals 110a and 110b can include one or more underlying or basic wagering games (e.g., slots/reels games, card games, keno games, etc.), one or more underlying or basic non-wagering games (e.g., non-wagering slots/reels games, non-wagering card games, non-wagering keno games, etc.), one or more bonus games (e.g., free spins on a slots/reels game, etc.), one or more community games (e.g., a Big Event game), or a combination thereof. The term underlying wagering games refers to games that permit a player to play in response to the player making a wager (e.g., a wager of credits or money). The term underlying non-wagering games refers to games that permit a player to play without having to make a wager (e.g., a wager of credits or money).

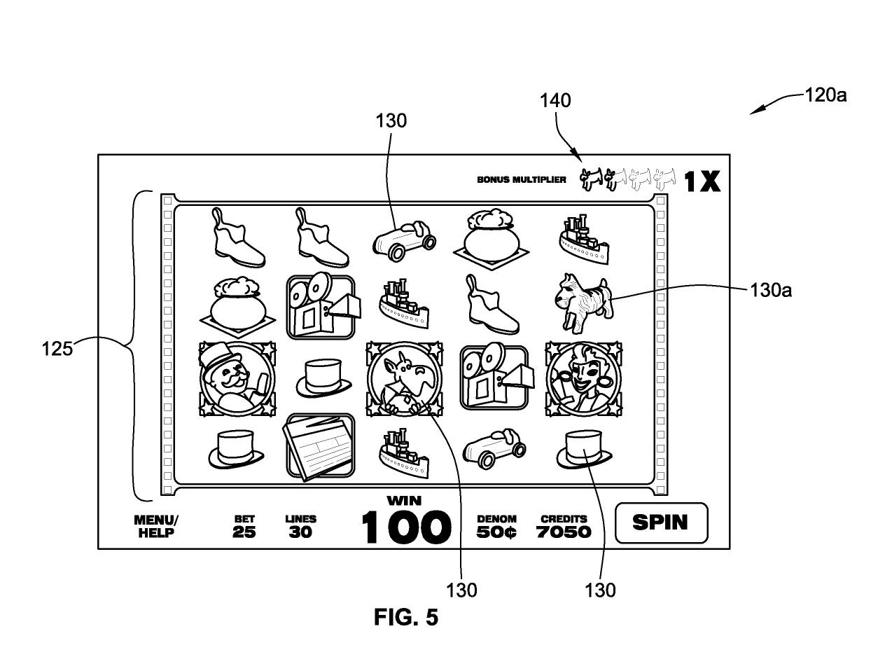

Each of the gaming terminals 110a includes a primary display area 112a and a secondary display area 114a, and each of the gaming terminals 110b includes a display area 112b. The primary display area 112a and/or the secondary display area 114a of the gaming terminals 110a and the display area 112b of the gaming terminals 110b can be used for displaying one or more portions of a wagering game and/or a non-wagering game. As shown in FIG. 5, an example screen shot 120a of the primary display area 112a and/or the secondary display area 114a of a first one of the gaming terminals 110a of the first type (hereinafter referred to as “the first gaming terminal 110a”) illustrates one play of a slots-type basic wagering game according to some aspects of the present disclosure.

The screen shot 120a includes an array of symbol positions 125 that can used in conducting the wagering game. The array of symbol positions 125 is a 4×5 matrix of symbol positions arranged in five columns and four rows (i.e., twenty symbol positions). The array of symbol positions 125 is formed by a plurality of symbol-bearing reels such that each of the columns is occupied by a single one of the reels and each of the reels bears at least a portion of a plurality of symbols 130. The symbol bearing reels can be mechanical reels, displayed simulated reels, or a combination thereof. While the array of symbol positions 125 is shown as including five columns and four symbol positions per column (i.e., four rows of symbol positions), any number of columns and rows can be provided. For example, the array of symbol positions can include 1, 2, 3, 4, 10, 20, n, etc. columns with 1, 2, 3, 4, 10, m, etc. rows.

While the first gaming terminal 110a conducts a play of the wagering game, each of the columns of the array of symbol positions 125, or each of the symbol-bearing reels, spins or illustrates a simulated spin (not shown) to appear as if each of the columns is spinning prior to displaying an outcome of symbols (FIG. 5). At the beginning of a first play of the basic wagering game, all of the columns spin and then stop spinning in a predetermined order (e.g., the first column stops spinning first and displays its outcome, then the second column stops and displays its outcome, etc.). As each column stops spinning, a portion of a randomly selected outcome of symbols is displayed on the primary display area 112a and/or the secondary display area 114a, until the entire outcome is displayed, as shown in FIG. 5.

Once the reels stop spinning and the outcome is displayed (FIG. 5), the outcome is evaluated to determine if it is a winning outcome. For example, an outcome of the wagering game is a winning outcome if it includes an award of winning symbols or at least one other type of award, such as a multiplier. An outcome can include multiple awards awarded to different players, for example to players of a wagering game being conducted on any of the gaming terminals 110a and to players of a wagering game being conducted on any of the gaming terminals 110b. In order for a symbol to be a winning symbol, and thus, contributing to the outcome being a winning outcome, the symbol must be part of one or more combinations of symbols on one or more lines of the wagering game, which correspond with one or more respective winning combinations of symbols included in a paytable of the wagering game. The paytable associates each possible winning combination, for the wagering game, with an award (e.g., credits) that is provided to the player of the wagering game once that winning combination is achieved. Thus, a winning outcome can include multiple combinations of symbols that correspond with respective winning combinations of symbols in the paytable. By the term line of the wagering game it is meant to include “paylines” in payline related wagering games and “ways” in any pay or any way related wagering games.

In addition to the outcome being evaluated to determine if it is a winning outcome, the outcome can be evaluated to determine if the outcome includes one or more special symbols 130a. The special symbols 130a appearing as part of an outcome of the basic wagering game can be collected by a player to increase the player's bonus multiplier for use in a community game. Each collected special symbol 130a increases the multiplier value by one unit. Each unit can increment the multiplier by an integer number (e.g., one or two, etc.) or a fraction of an integer number (e.g., ¼, ½, etc.). In the case of the multiplier including a faction (e.g., achieved multiplier is 1.25× or 2.7×) when the community game is triggered, the multiplier value used during play of the community game is rounded down (e.g., achieved multiplier of 1.25× is used as a multiplier of 1×).

As shown in the outcome of FIG. 5, the symbol position second from the top in the fifth column of the array of symbol positions 125 is associated with a special symbol 130a. In the illustrated example, the special symbol 130a is a dog-token symbol; however, the special symbol can be any other type or kind of symbol. The player's progress of collecting the special symbols 130a—to achieve a multiplier for use during the community game—during play of the basic wagering game is shown in the multiplier area 140 of the screen shot 120a. As shown, the player has achieved a 1× multiplier thus far and is still working on collecting additional special symbols 130a to achieve the next multiplier level (e.g., a 2× multiplier).

The players of the gaming terminals 110a can continue playing the basic wagering game by spinning and re-spinning the reels of the basic wagering game to try and win additional credits (e.g., corresponding to and redeemable for real money) and to increase their respective multiplier prior to the community game being triggered. The community game can be triggered by the gaming server, by one of the gaming terminals 110a of the first type, or a combination thereof The community game is triggered for the players of the gaming terminals 110a periodically (e.g., every three, four, five, etc. minutes). That is, the community game is triggered (e.g., starts to be conducted) at a set interval of time (e.g., every four minutes). Alternatively, the community game can be triggered randomly as a mystery trigger (e.g., based on a RNG), in response to a player of the wagering game achieving a predetermined trigger outcome, etc.

After the community game is triggered, a determination is made as to which players of the gaming terminals 110a, 110b are eligible to join and play the community game. The determination of eligibility can be made by the gaming server, by one or more of the gaming terminals 110a of the first type, or a combination thereof. The players of the gaming terminals 110a of the first type are eligible to join the triggered community game if an eligibility criterion (e.g., a first eligibility criterion) is satisfied. The eligibility criterion can be, for example, whether a player is actively playing the underlying wagering game in a time period prior to the community game being triggered. The eligibility criterion can further include, for example, whether the player is actively playing the underlying wagering game in a time period prior to the community game being triggered at a predetermined rate of coin-in. For another example, the eligibility criterion can be whether a player collected a predetermined number (e.g., one, two, etc.) of special symbols (e.g., special symbols 130a) prior to the community game being triggered. For yet another example, the eligibility criterion can be whether a player has collectively spent a predetermined amount of credits during play of the basic wagering game prior to the community game being triggered.

Similarly, the players of the gaming terminals 110b of the second type are eligible to join the triggered community game if an eligibility criterion (e.g., a second eligibility criterion that is different than the first eligibility criterion) is satisfied. For example, the eligibility criterion for the players of the gaming terminals 110b of the second type is whether the player purchased eligibility to play the community game by, for example, placing one or more side wagers prior to the community game being triggered. In some implementations, the players of the gaming terminals 110b of the second type can gain instant eligibility for the community game with the placing of a side wager as the act of placing a side wager itself permits the players to participate in the community game.

Once a determination has been made that one or more of the players of the gaming terminals 110a, 110b are eligible to play the community game, the community game is conducted by displaying the community game and its outcome on the community display device 200 and/or on the display area 112b of the gaming terminals 110b. In some implementations, the community game, its outcome, representations of the outcome, or any portion thereof can be displayed on the primary and/or the secondary display areas 112a, 114a of the gaming terminals 110a, the display area 112b of the gaming terminals 110b, the community display device 200, or any combinations thereof.

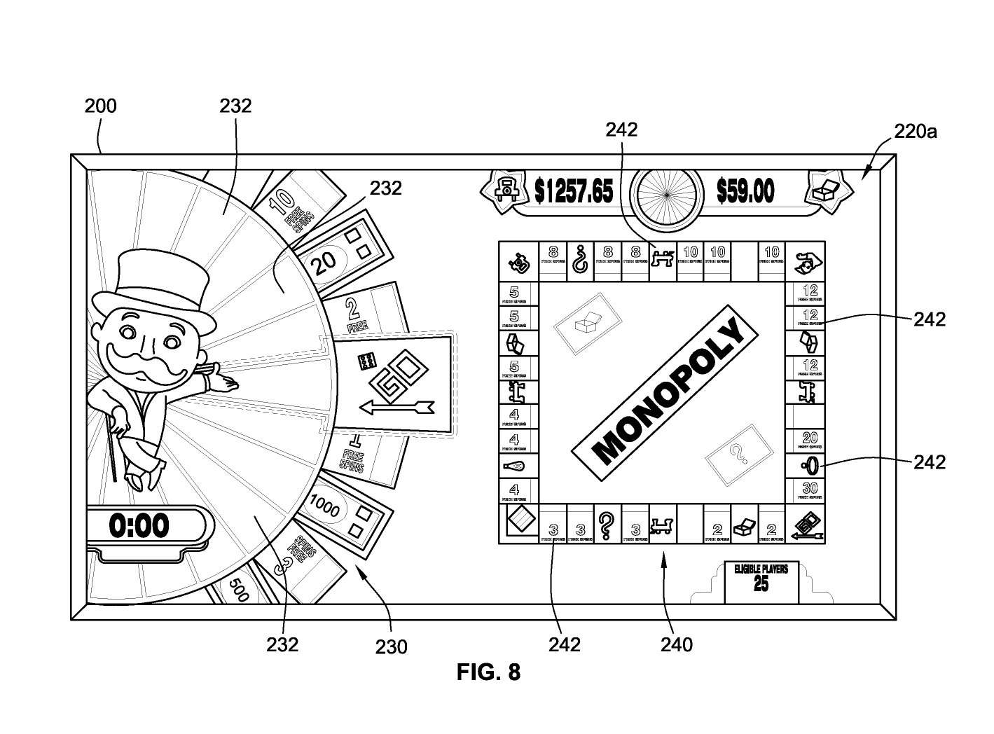

Generally, as shown in FIG. 8, the community game includes a wheel 230 (e.g., a virtually spinning wheel) and a board 240 (e.g., a MONOPOLY themed board). The wheel 230 has a plurality of sections or slices 232. Each of the sections 232 is associated with a position 242 of the board 240 (e.g., Boardwalk, Go, Free parking, etc.) or a bill (e.g., 20 dollar bill, 500 dollar bill, etc.). Additionally, awards are associated with each of the sections 232 and/or each of the positions 242. For the sections 232 that are associated with a position 242 of the board 240, the award can be free plays or spins of a reel bonus game or a trigger to a Once-Around-Bonus aspect. For the sections 232 that are associated with a bill, the award can be credits (e.g., a 20 dollar bill can be associated with an award of twenty credits, etc.).

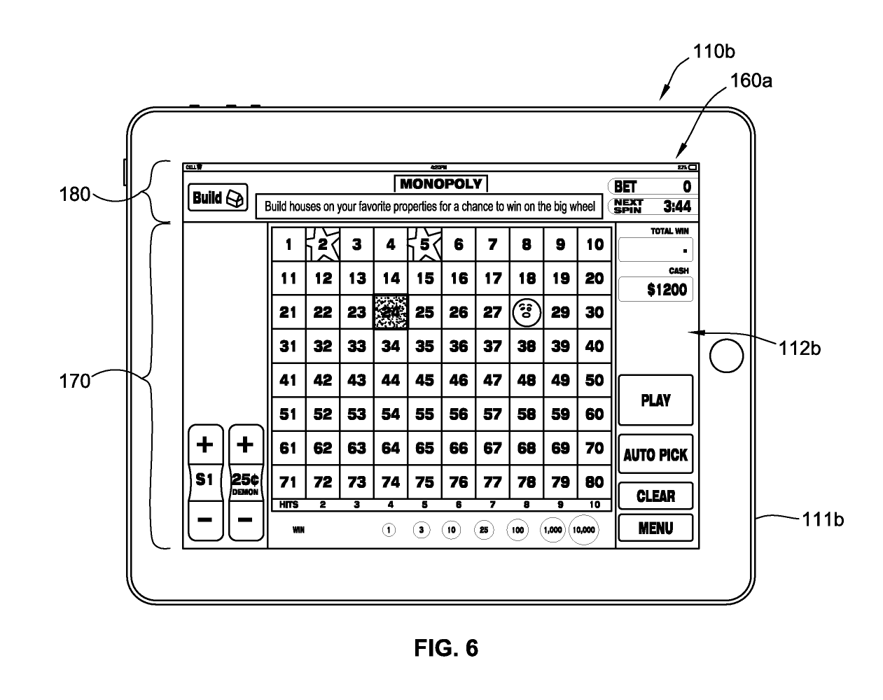

As shown in FIG. 6, a screen shot 160a of the display area 112b of a first one of the gaming terminals 110b of the second type (hereinafter referred to as “the second gaming terminal 110b”) illustrates a keno-type basic wagering game 170 and a side-wager or side-game bar 180 (e.g., dropdown menu). The keno-type basic wagering game 170 can be played by a player according to known methods for playing keno. Alternatively, the keno-type basic wagering game 170 can be any other type of basic wagering game (e.g., slots type, card type, etc.). The screen shot examples on the gaming terminals 110b discussed herein can be portrayed on a web page displayed by a web browser running on any of the gaming terminals 110b, for example.

In some implementations, the keno-type basic wagering game 170, played on the gaming terminals 110b of the second type, is a slow playing wagering game (e.g., low or slow coin-in wagering game) as compared to a slots-type wagering game that is a relatively faster playing wagering game (e.g., high or fast coin-in wagering game). Thus, players of low coin-in wagering games typically spend less credits (e.g., money) over a set period of time as compared to players of high coin-in wagering games. In some alternative implementations, the keno-type basic wagering game 170 can be a non-wagering game. That is, players of the gaming terminals 110b of the second type can play only non-wagering games prior to joining the community game as described herein.

The side-wager bar 180 provides information about the community game (e.g., the same community game playable by the players of the gaming terminals 110a) and provides access for the player of the second gaming terminal 110b to join the community game according to some aspects of the disclosed concepts. To be eligible to participate in the community game, the player of the second gaming terminal 110b first activates the side-wager bar 180 and then purchases eligibility to participate in the community game by, for example, placing one or more side wagers. The side-wager bar 180 can be activated by, for example, touching a portion of the side bar 180 (e.g., pressing the side-wager bar 180 with a fingertip and sliding the fingertip downward). Once activated, the side-wager bar 180 extends to cover all of, or a major portion of, the display area 112b.

As noted herein, the eligibility requirement for participating in the community game is different for players of the gaming terminals 110a versus players of the gaming terminals 110b. That is, the community game has varying eligibility requirements. In this example, players of the gaming terminals 110b must directly purchase their eligibility to participate in the community game, whereas players of the gaming terminals 110a need not, but rather attain participation eligibility by satisfying a different criterion. In some implementations, for example, eligibility to play the community game for a first player of one of the gaming terminals 110a of the first type is dependent upon the first player playing an underlying wagering game (e.g., placing wagers to play a wagering game), whereas eligibility to play the community game for a second player of one of the gaming terminals 110b of the second type is not dependent upon the second player playing an underlying wagering game (e.g., the second player can play a non-wagering game or no game at all on the gaming terminal 110b prior to being permitted to play the community game).

By the term “dependent upon” it is meant that in order for the player of the first gaming terminal 110a to play the community game, the player must be playing an underlying wagering game (e.g., a slots-type wagering game) prior to the triggering of the community game. By “playing” it is meant that the player is placing (or has placed) one or more wagers on the underlying wagering game. Thus, for example, suppose a player of the first gaming terminal 110a placed twenty wagers (ranging from 10 to 100 credits) over the course of three minutes immediately prior to the triggering of the community game. In such an example, the player is considered to be playing the underlying wagering game and thus eligible to play the community game. Of course, requirements in addition to playing an underlying wagering game for gaining eligibility to play the community game can be implemented as described herein (e.g., collecting special symbols, playing the underlying wagering game at a predetermined rate of coin-in, etc.).

By the term “not dependent upon” it is meant, for example, that the player of the second gaming terminal 110b does not have to play an underlying wagering game prior to the triggering of the community game in order for the player to be able to play the community game. Thus, the player can simply be playing an underlying non-wagering game, browsing the internet, or simply waiting for the community game to be conducted immediately prior to the triggering of the community game. Alternatively, the player of the second gaming terminal 110b can be playing an underlying wagering game immediately prior to the triggering of the community game. Thus, for example, suppose a player of the second gaming terminal 110b browsed the internet on a web browser over the course of three minutes immediately prior to the triggering of the community game. In such an example, the player is not playing an underlying wagering game; yet, the player can still be eligible for playing the community game. Of course, affirmative requirements for gaining eligibility to play the community game can be implemented as described herein (e.g., placing one or more side wagers, etc.). In fact, in some implementations, players of the gaming terminals 110b of the second type can gain instant eligibility to play the community game by making such side wagers.

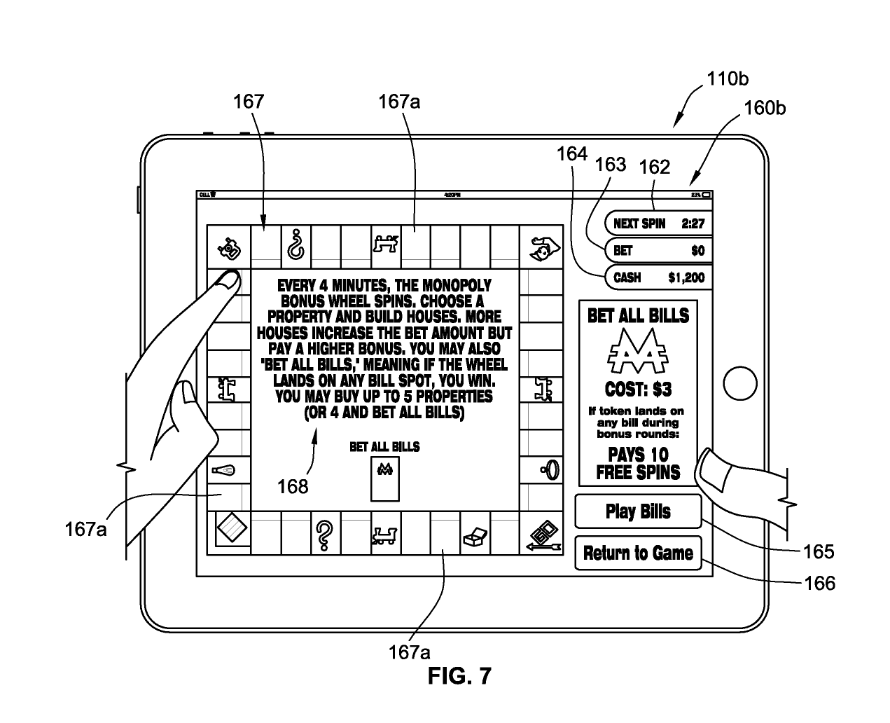

As shown in FIG. 7, a screen shot 160b illustrates some aspects of the community game once the side-wager bar 180 is activated on the second gaming terminal 110b. The aspects of the community game illustrated in the screen shot 160b include a countdown timer 162 that indicates when the next play of the community game will occur. As shown, the next play (e.g., spin of a wheel 230, shown in FIG. 8) will occur in two minutes and twenty-seven seconds. Thus, the player of the second gaming terminal 110b has just under two and a half minutes to join the community game by purchasing eligibility (e.g., placing one or more side wagers).

Some of the other aspects of the community game illustrated in the screen shot 160b include a wager amount meter 163, a cash amount meter 164, a play bills selectable element 165, a return to game selectable element 166, a board representation 167 of the board 240 (shown in FIG. 8), and instructions 168. The wager amount meter 163 indicates the amount of side wagers placed on one or more of the positions 242 (shown in FIG. 8) of the board 240. For example, by following the instructions 168, a player can select a first representative board position 167a (e.g., corresponding to a position 242 on the board 240 shown in FIG. 8) that is associated with a property (e.g., Mediterranean Ave.) and place a side wager thereon (e.g., 2 dollars) and the wager amount meter 163 will indicate that a total wager of 2 dollars has been made by the player of the second gaming terminal 110b.

The cash amount meter 164 indicates the amount of cash or credits in an account of the player of the second gaming terminal 110b. In some implementations, the player of must log in or sign into the account for the account value or credits to appear in the cash amount meter 164. As the player makes side wagers on the positions 242 of the board 240 (e.g., by selecting the representative board positions 167a and placing side wagers), the amount of cash indicated by the cash amount meter 164 decreases accordingly. Similarly, after the player wins one of the side wagers placed on a position 242 (e.g., if the side wager is made on a position that is randomly chosen as a winning position during play of the community game), any award in cash and/or credits achieved is reflected by the cash amount meter 164.

The play bills selectable element 165 is a softkey button that can be selected and/or pressed by the player of the second gaming terminal 110b to place a side wager on some or all of the sections 232 of the wheel 230 associated with a bill. Thus, the play bills selectable element 165 provides a convenient way to place side wagers one or multiple potential winning sections 232 of the wheel 230.

If the player of the second gaming terminal 110b does not want to participate in the community game or if the player is done making side wagers, the player can exit the community game and continue to play the keno-type basic wagering game 170 (or any other type of basic wagering game) by selecting and/or pressing the return to game selectable element 166 (e.g., returning from the screen shot 160b of FIG. 7 to the screen shot 160a of FIG. 6).

As mentioned above, the board representation 167 is a representation (e.g., a graphical and/or virtual reproduction) of the board 240 of the community game shown in FIG. 8. The board representation 167 includes a plurality of representative board positions 167a that correspond to positions 242 on the board 240. Thus, a side wager made by the player on a representative board position 167a results in a side wager being made on the board 240 on the corresponding position 242.

The instructions 168 provide a quick reference for the player of the second gaming terminal 110b to make side wagers. Various other types of instructions can be provided. Further, the content of the instructions 168 can be different depending on the parameters of the community game implemented.

Referring to FIG. 8, a screen shot 220a of the community display device 200 illustrates a play of the community game. The players of the second type of gaming terminals 110b can actively purchase eligibility to join the community game by selecting and placing side wagers on one or more of the positions 242 of the board 240 via the board representation 167 as described above (e.g., using the representative board positions 167a). For example, the player of the second gaming terminal 110b can select up to five positions 242 associated with five MONOPOLY properties (e.g., Kentucky Ave., Boardwalk, Pacific Ave., Marvin Gardens, and New York Ave.) and place side wagers thereon. By placing a side wager on a position 242 associated with a property, the player is wagering that the position 242 (with the side wager thereon) will be randomly selected as a winning position during play of the community game.

The side wagers placed by the player of the second gaming terminal 110b can be represented on the board 240 and/or on the board representation 167 of the community game as houses and/or hotels. The number of houses built on a particular position (e.g., property) represents the size of the side wager made by the player and the size of a multiplier associated therewith. For example, four houses built on the position 242 associated with the Boardwalk property indicates a side wager of sixteen dollars (e.g., four dollars per house) on that position with a 4× multiplier and two houses built on New York Ave. indicates a side wager of four dollars (e.g., two dollars per house) on that position with a 2× multiplier.

After the community game is triggered and the eligible players of the first type of gaming terminals 110a are determined and the joining players of the second type of gaming terminals 110b place their side wagers (e.g., the side wagers can be placed prior to or after the community game is triggered), the wheel 230 spins and one of the sections 232 is randomly selected as a winning section (e.g., Mr. Monopoly points to a winning section). At the conclusion of the community game, the award associated with the winning section is automatically provided to all eligible players of the first type of gaming terminals; however, only players of the second type of gaming terminals that placed a side wager on the position 242 of the board 240 that corresponds with the winning section 232 of the wheel 230 are provided with the award associated with the winning section 232.

For example, if the player of the second wagering terminal 110b built two houses on the position 242 associated with the Mediterranean Ave. property, thereby placing a side wager of two dollars (e.g., one dollar per house) on Mediterranean Ave., and the section 232 of the wheel 230 associated with Mediterranean Ave. is selected as the winning section of the community game, then the player of the second gaming terminal 100b will be provided with the award (e.g., two free plays of a reel bonus game) at a 2× multiplier level, for a total of, for example, four free plays of the reel bonus game. However, if the player of the second wagering terminal 110b built four houses on Boardwalk, thereby placing a side wager of sixteen dollars (e.g., four dollars per house) on Boardwalk, and the section 232 of the wheel 230 associated with Mediterranean Ave. is selected as the winning section of the community game, then the player of the second gaming terminal 110b will not be provided with the award (e.g., two free plays of a reel bonus game) at a 4× multiplier level, because the player of the second wagering terminal 110b failed to place a side wager on a position 242 that corresponds with the randomly selected winning section 232 (which in this example is Mediterranean Ave. and not Boardwalk).

However, players of the wagering terminals 110a of the first type that are determined to be eligible for playing the community game (e.g., the player was actively playing the underlying wagering game when the community game was triggered), will receive the awards associated with the randomly selected winning sections 232 at their respective multiplier level regardless of what properties are associated with side wagers placed by players of the second type of gaming terminals 110b. That is, players of the gaming terminals 110a do not need to place side wagers on the positions 242 of the community game in order to be eligible to play and win award(s) associated with the community game. Thus, in the above example, all eligible players of the gaming terminals 110a would be provided with the award associated with the winning section 232 (e.g., Mediterranean Ave.) at their respective multiplier level.

According to some implementations of the community game, one of the sections 232 of the wheel is associated with a Once-Around-Bonus trigger (e.g., the Go position). In such implementations, if the section 232 of the wheel 230 associated with the Once-Around-Bonus trigger is randomly selected as the winning section (as shown in FIG. 8), a Once-Around-Bonus aspect of the community game is conducted (e.g., played).

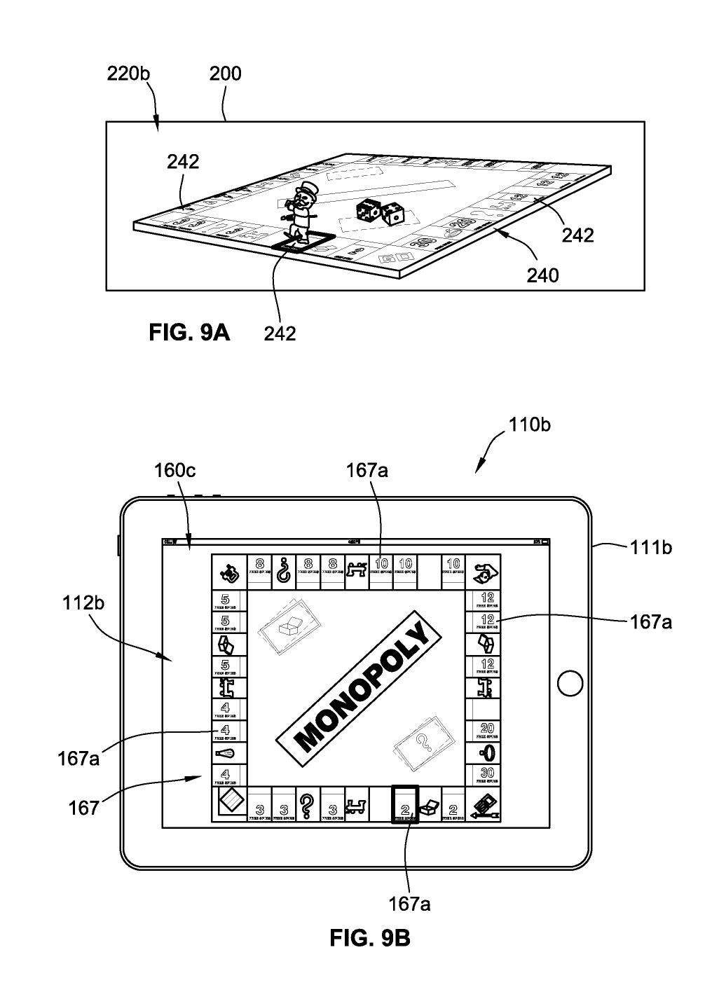

After the Once-Around-Bonus aspect is triggered, the wheel 230 visually disappears and the board 240 is highlighted to the players. Specifically, the board 240 can be displayed to the players of the gaming terminals 110a on the community display device 200 and to the players of the gaming terminals 110b on the display areas 112b. As shown in FIG. 9A, a screen shot 220b illustrates the board 240 on the community display device 200 in a three-dimensional perspective view. However, as shown in FIG. 9B, a screen shot 160c illustrates the board representation 167 on the display area 112b of the second gaming terminal 110b in a two-dimensional top view. The Once-Around-Bonus aspect involves dice being virtually rolled and advancing a game token (e.g., Mr. Monopoly) around the board 240. Each position 242 that the game token lands upon during play of the Once-Around-Bonus aspect of the community game is randomly selected as a winning position. The Once-Around-Bonus aspect continues until the game token completes one trip around the board 240. The winning positions can be highlighted on the board 240 and/or on the board representation 167 to indicate to the players which of the positions 242 are winning positions. In some implementations, the community display device 200 displays the community game and the display areas 112b of the gaming terminals 110b of the second type display a representation of the community game, including a representation of the outcome of the community game.

At the conclusion of the Once-Around-Bonus aspect of the community game, the awards associated with each of the winning positions 242 are automatically provided to all eligible players of the gaming terminals 110a of the first type; however, only players of the gaming terminals 110b of the second type that placed a side wager on the winning positions 242 are provided the award(s) associated therewith.

For example, suppose the player of the second wagering terminal 110b built (i) four houses on Mediterranean Ave., thereby placing a side wager of four dollars (e.g., one dollar per house) on Mediterranean Ave., (ii) four houses on New York Ave., thereby placing a side wager of eight dollars (e.g., two dollars per house) on New York Ave., (iii) four houses on Kentucky Ave., thereby placing a side wager of twelve dollars (e.g., three dollars per house) on Kentucky Ave., (iv) four houses on Pacific Ave., thereby placing a side wager of sixteen dollars (e.g., four dollars per house) on Pacific Ave., and (v) two houses on Boardwalk, thereby placing a side wager of eight dollars (e.g., four dollars per house) on Boardwalk. Then suppose that during the Once-Around-Bonus aspect, the game token randomly selected and landed on positions 242 associated with the Oriental Ave. property, then the New York Ave. property, then the Illinois Ave. property, then the Pacific Ave. property, and then the Go property/space; where Oriental Ave. is associated with an award of three free plays of a reel bonus game, New York Ave. is associated with an award of five free plays of a reel bonus game, Illinois Ave. is associated with an award of eight free plays of a reel bonus game, Pacific Ave. is associated with an award of twelve free plays of a reel bonus game, and Go is associated with no award. The outcome of the Once-Around-Bonus aspect is then the positions 242 associated with the following properties: Oriental Ave., New York Ave., Illinois Ave., and Pacific Ave. As the player of the second wagering terminal 110b only placed side wagers on two of the four winning positions, only the awards associated with those two winning positions are provided to the player of the second wagering terminal 110b. In this example, the player of the second wagering terminal 110b would be awarded with five free plays of a reel bonus game at a 4× multiplier for placing the four houses on the position 242 associated with the New York Ave. property plus twelve free plays of the reel bonus game at a 4× multiplier for placing the four houses on the position 242 associated with the Pacific Ave. property for a total of sixty-eight free plays (20+48=68).

However, each of the players of the gaming terminals 110a of the first type that were eligible to play the community game, would be awarded with all of the awards associated with the positions 242 associated with the Oriental Ave., New York Ave., Illinois Ave., and Pacific Ave. properties at the players' respective multiplier level achieved prior to the community game being triggered. For a player of the first gaming terminal 110a with a multiplier of 1×, the player would be awarded with three free plays of a reel bonus game at a 1× multiplier for the game token landing on the position 242 associated with the Oriental Ave. property plus five free plays of a reel bonus game at a 1× multiplier for the game token landing on the position 242 associated with the New York Ave. property plus eight free plays of a reel bonus game at a 1× multiplier for the game token landing on the position 242 associated with the Illinois Ave. property plus twelve free plays of the reel bonus game at a 1× multiplier for the game token landing on the position 242 associated with the Pacific Ave. property for a total of twenty-eight free plays (3+5+8+12=28).

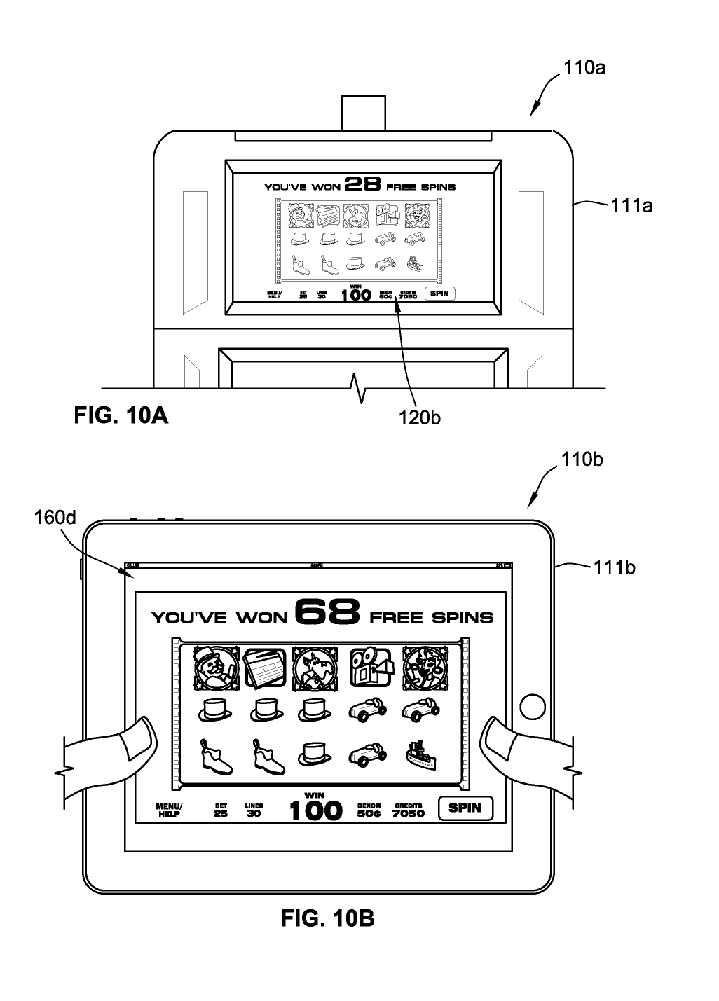

In the case that the awards determined for each eligible player in the community game include free plays of a reel bonus game, the free plays are carried out and displayed to the players. For example, in the above example, the player of the first gaming terminal 110a won twenty-eight free plays and the player of the second gaming terminal 110b won sixty-eight free plays. Thus, as shown in a screen shot 120b of FIG. 10A, the primary and/or secondary display area 112a and/or 114a of the first gaming terminal 110a displays the twenty-eight free plays and any awards (e.g., credits) associated therewith to the player of the first gaming terminal 110a. Similarly, as shown in a screen shot 160d of FIG. 10B, the display area 112b of the second gaming terminal 110b displays the sixty-eight free plays and any awards (e.g., credits) associated therewith to the player of the second gaming terminal 110b.

As described above, multipliers achieved (e.g., players of the gaming terminals 110a of the first type) and multipliers purchased (e.g., players of the gaming terminals 110b of the second type) can be used to increase the number of free plays of the reel bonus game achieved during play of the community game (e.g., an award of five free plays is multiplied by a 2× multiplier for an award of ten free plays). Alternatively, the multipliers are not applied to increase the number of free plays of the reel bonus game, but rather are used to increase any awards achieved during the free plays of the reel bonus game. For example, suppose a player of the gaming terminal 110a of the first type is permitted to participate in the community game because the player was actively playing the underlying wagering game when the community game was triggered. At the time the community game was triggered, the player had achieved a multiplier of 3× (e.g., the player collected a sufficient number of special symbols to achieve a 3× multiplier). During play of the community game, winning positions 242 associated with two, five, and twelve free plays of the reel bonus game are randomly selected. Thus, the player won a total of nineteen free plays of the reel bonus game. After the community game, the nineteen free plays of the reel bonus game are conducted, which results in an award of, for example, three hundred credits. The award of three hundred credits is then multiplied by the player's achieved 3× multiplier for a total bonus award of nine hundred credits achieved by the player.

Alternatively to the gaming terminals 110b of the second type being thin clients, the gaming terminals 110b of the second type can be intermediate clients and/or thin clients. By intermediate client, as described above, it is meant that the housing 111b of each of the second type of gaming terminals 110a includes any one or two of, but not all three of, an RNG, game logic, and game assets therein (e.g., the game logic and game assets are onboard and the RNG is external, or the game assets are onboard and the RNG and the game logic are external).

As mentioned above, the community game includes positions 242 and sections 232 that are associated with awards. Some of the awards are credits and/or money and others of the awards are free plays of a bonus game that can result in awards of credits and/or money. The resulting awards of credits and/or money are funded by the players of the gaming terminals 110a, 110b. Specifically, the players make wagers of credits and/or money to play the wagering games. A portion of the wagers made are used to effectively fund (e.g., payout) awards related to the community game. In some implementations, awards achieved during the community game by a player of the gaming terminals 110a of the first type are effectively funded by a percentage (e.g., 33%) of the wagers placed on the underlying wagering games played thereon by the player of the gaming terminals 110a. Additionally, in some implementations awards achieved during the community game by a player of the gaming terminals 110b of the second type are effectively funded by a percentage (e.g., 100%) of the side wagers placed on the community game played thereon by the player of the gaming terminals 110b. In such implementations, any wagers placed by the players of the gaming terminals 110b of the second type on underlying wagering games (i.e., not the side wagers on the community game) played thereon (e.g., keno-type basic wagering game) do not fund the community game.

Thus, a difference between the gaming terminals 110a of the first type and the gaming terminals 110b of the second type is how they each effectively fund the community game. However, while the gaming terminals 110a and the gaming terminals 110b effectively fund the community game in a different manner, the outcome of the community game (e.g., the randomly selected winning positions 242) is the same for all players of the community game including the players of the gaming terminals 110a and the players of the gaming terminals 110b. While the outcome is the same for all players, the award(s) achieved by the players is not necessarily the same. For example, the awards for each player are based on the player's respective multiplier and, for the players of the gaming terminals 110b of the second type, on the side wagers made by the player. Thus, the community game of the present disclosure has a shared communal experience (e.g., same outcome for all players) with different effective funding and award mechanisms for different types of gaming terminals (e.g., different for traditional thick client, floorstanding terminals primarily dedicated to gaming and thin client, handheld terminals that are not primarily dedicated to gaming).

According to some implementations of the present disclosure, an overall payback percentage of the wagering game (e.g., including an underlying wagering game and the community game) can be different for players of the gaming terminals 110a of the first type than for players of the gaming terminals 110b of the second type. For example, players of the wagering game via the gaming terminals 110a of the first type can enjoy a first overall payback percentage (e.g., 85%, 90%, etc.) and players of the gaming terminals 110b of the second type can enjoy a second overall payback percentage (e.g., 95%, 97%, etc.) that is different than the first payback percentage. Alternatively, the overall payback percentage for players of a wagering game (e.g., including an underlying wagering game and the community game) is the same regardless of the type of gaming terminal used by the players.

In some implementations of the present disclosure, players of the community game on the gaming terminals 110b of the second type are limited to placing side wagers on a predetermined number of positions 242 of the board 240. For example, the players can be limited to placing side wagers on five or fewer positions 242. Thus, the players of the community game via the gaming terminals 110b of the second type have an inferior chance of winning (or the perception of an inferior chance) the community game as compared to the players of the community game via the gaming terminals 110a of the first type.

The gaming terminals 110b of the second type can be provided by a variety of different manufacturers. In some implementations, the available wagering games (e.g., underlying wagering games) for a player of one of the gaming terminals 110b of the second type is based on the manufacturer of the gaming terminal. For example, a first basic wagering game might only be available for play on gaming terminals manufactured by a first manufacturer.

The gaming server can also be configured to download to the various gaming terminals 110b different forms of the game logic or game assets needed to conduct a wagering game on the gaming terminals 110b. For example, the game logic can be in precompiled, object-code form, and are downloaded in the same form from the gaming server to one or more of the gaming terminals 110b of the second type. Because the game logic is already in object-code form, it can be executed directly by the platform (e.g., operating system) being hosted by the client gaming terminal 110b. Alternately, the game logic can be embodied as interpretive code that is interpreted and executed in real time by another client gaming terminal 110b. The game assets can be streamed from the gaming server to any of the gaming terminals 110b on demand, i.e., only as needed by the game logic for presentation of the outcome. Thus, in some aspects, different types of clients 110a, 110b require different eligibility criteria to be satisfied for participation in the same community game, evaluate the same outcome of the community game to determine which awards are to be awarded to players using the different clients, and award different awards to the players as a function of the type of client they are using. Further, optionally, the gaming server can, for each of the gaming terminals 110a, 110b, determine whether to download requested game logic and/or game assets in pre-compiled, object-code form, or as interpreted by an interpreter, such as a JAVA or JSON interpreter, as a function of the client requesting the game logic or game assets from the gaming server.

Moreover, different or additional authentication schemes are required for the players using the gaming terminals 110b versus those using the gaming terminals 110a. Any player can purchase eligibility to place a side wager on a community game using a gaming terminal 110b, such as by taking a picture of a QR code and accessing the web page embedded in the URL encoded in the QR code, and accordingly, additional authentication measures are required to associate the proper player account with the player using the gaming terminal 110b. It should be emphasized that the gaming terminals 110b can be the player's own personal portable computing device that the player brings into a gaming establishment, such that it is “transformed” from a computing device into a gaming terminal once the player accesses the web page(s) corresponding to the community game. Once transformed, the player is able to participate in the community game using a thin client device that has no affiliation or association with an operator of the gaming establishment, with any manufacturer of the gaming terminals 110a, or with any owner or licensor of the wagering game including the community game.

Each of the above concepts and obvious variations thereof is contemplated as falling within the spirit and scope of the claimed invention, which is set forth in the following claims.

What is claimed is:

1. A computer-implemented method, comprising:
displaying a community game on at least one display device;
dependent upon a first player playing an underlying wagering game via a first terminal, permitting the first player to participate in the community game, the community game being distinct from the underlying wagering game; and
not dependent upon a second player playing an underlying wagering game via a second terminal, permitting the second player to participate in the community game.

2. The computer-implemented method of claim 1, wherein the first terminal is a floorstanding terminal primarily dedicated for playing wagering games thereon, and wherein the second terminal is a handheld device not primarily dedicated for playing wagering games thereon.

3. The computer-implemented method of claim 1, further comprising causing the community game to be triggered, wherein the permitting the first player to participate in the community game is dependent upon the first player actively playing the underlying wagering game in a time period prior to the community game being triggered, and wherein permitting the second player to participate in the community game is responsive to receipt of a side wager placed by the second player on the community game via the second terminal.

4. The computer-implemented method of claim 1, wherein the permitting the first player to participate in the community game is dependent upon the first player playing the underlying wagering game, via the first terminal, at or above a predetermined rate of coin-in.

5. The computer-implemented method of claim 1, wherein the displayed community game includes a plurality of positions, each of the positions being associated with an award, the computer-implemented method further comprising:
causing the community game to be triggered;
randomly selecting one of the positions as a winning position; and
awarding the award associated with the winning position to the first player in response to permitting the first player to participate in the community game.

6. The computer-implemented method of claim 5, further comprising awarding the award associated with the winning position to the second player in response to the second player placing a side wager on the winning position prior to the community game being triggered.

7. The computer-implemented method of claim 1, further comprising:
capturing a QR code using a camera of the second terminal; and
in response to the capturing, displaying a menu of wagering games on a display device of the second terminal, the menu including the community game.

8. A gaming system for conducting a wagering game including a community game, the gaming system comprising:
one or more display devices;
one or more processors; and
one or more memory devices storing instructions that, when executed by at least one of the one or more processors, cause the gaming system to:
display a community game on at least one of the one or more display devices;
dependent upon a first player playing an underlying wagering game via a first terminal, permit the first player to participate in the community game, the community game being distinct from the underlying wagering game; and
not dependent upon a second player playing an underlying wagering game via a second terminal, permit the second player to participate in the community game.

9. The gaming system of claim 8, wherein the first terminal is a floorstanding terminal primarily dedicated for playing wagering games thereon, and wherein the second terminal is a handheld device not primarily dedicated for playing wagering games thereon.

10. The gaming system of claim 8, wherein the gaming system is further caused to trigger the community game and to permit the first player to participate in the community game in response to the first player collecting one or more special symbols during play of the underlying wagering game prior to the gaming system being caused to trigger the community game.

11. The gaming system of claim 8, wherein the gaming system is further caused to trigger the community game, and wherein the gaming system is caused to permit the first player to participate in the community game in response to the first player actively playing the underlying wagering game in a time period prior to the gaming system being caused to trigger the community game.

12. The gaming system of claim 11, wherein the gaming system is further caused to permit the second player to participate in the community game in response to the second player placing a side wager on the community game via the second terminal.

13. One or more physical machine-readable storage media including instructions which, when executed by one or more processors, cause the one or more processors to perform operations comprising:
displaying a community game on at least one display device;
dependent upon a first player playing an underlying wagering game via a first terminal, permitting the first player to participate in the community game, the community game being distinct from the underlying wagering game; and
not dependent upon a second player playing an underlying wagering game via a second terminal, permitting the second player to participate in the community game.

14. The one or more physical machine-readable storage media of claim 13, the operations further comprising causing the community game to be triggered, wherein the permitting the second player to participate in the community game is in response to receiving a side wager placed by the second player on the community game via the second terminal prior to the community game being triggered.

15. A computer-implemented method, comprising:
displaying a community game on at least one display device;
dependent upon a first player playing a first underlying wagering game via a first terminal wherein the first underlying wagering game funds the community game, permitting the first player to participate in the community game; and
dependent upon a second player playing a second underlying wagering game via a second terminal wherein the second underlying wagering game does not fund the community game, permitting the second player to participate in the community game.

16. The computer-implemented method of claim 15, further comprising causing the community game to be triggered, and wherein the permitting the second player to participate in the community game is in response to receiving a side wager placed by the second player on the community game via the second terminal prior to the community game being triggered.

17. The computer-implemented method of claim 16, wherein the community game is triggered periodically at a constant time interval.

18. The computer-implemented method of claim 15, wherein the first terminal is a floorstanding terminal primarily dedicated to wagering games, and wherein the second terminal is a handheld device not primarily dedicated to wagering games.

19. The computer-implemented method of claim 15, wherein the first terminal has game logic for determining an outcome of the first underlying wagering game based on a randomly generated number and wherein the second terminal lacks game logic for determining an outcome of the second underlying wagering game.

20. The computer-implemented method of claim 15, wherein the first terminal is a thick client including a random number generator (RNG), game logic, and game assets and the second terminal is a thin client lacking a RNG, game logic, and game assets.

21. One or more physical machine-readable storage media including instructions which, when executed by one or more processors, cause the one or more processors to perform operations comprising:
displaying a community game on at least one display device;
dependent upon a first player playing a first underlying wagering game via a first terminal wherein the first underlying wagering game funds the community game, permitting the first player to participate in the community game; and
dependent upon a second player playing a second underlying wagering game via a second terminal wherein the second underlying wagering game does not fund the community game, permitting the second player to participate in the community game.

22. The one or more physical machine-readable storage media of claim 21, the operations further comprising causing the community game to be triggered, wherein the permitting the second player to participate in the community game is in response to receiving a side wager placed by the second player on the community game via the second terminal prior to the community game being triggered.

23. The one or more physical machine-readable storage media of claim 21, wherein the first terminal is a floorstanding terminal primarily dedicated to wagering games, and wherein the second terminal is a handheld device not primarily dedicated to wagering games.

24. The one or more physical machine-readable storage media of claim 21, wherein the first terminal has game logic for determining an outcome of the first underlying wagering game based on a randomly generated number and wherein the second terminal lacks game logic for determining an outcome of the second underlying wagering game.

25. The one or more physical machine-readable storage media of claim 21, wherein the first terminal is a thick client including a random number generator (RNG), game logic, and game assets and the second terminal is a thin client lacking a RNG, game logic, and game assets.
